(19) United States
(12) Patent Application Publication
(10) Pub. No.: US 2013/0318459 A1
(43) Pub. Date: Nov. 28, 2013

(54) PERSONALIZED ACTIVITY E-BOOK

(71) Applicant: Carla Taylor, Alexandria, VA (US)

(72) Inventor: Carla Taylor, Alexandria, VA (US)

(21) Appl. No.: 13/903,884

(22) Filed: May 28, 2013

Related U.S. Application Data
(60) Provisional application No. 61/651,953, filed on May 25, 2012.

(51) Int. Cl. G06F 3/0484; G06F 3/0486

(52) U.S. Cl. CPC G06F 3/0484; G06F 3/0486
USPC 715/769; 715/780

(57) ABSTRACT

A personalized activity electronic book with at least two template pages, where the template pages are have at least two fields, where two of the at least two fields are a media field and an information field and where all template pages have at least media input and at least text input.

### FIELD OF THE INVENTION

The present invention is directed to a personalized activity electronic book, heretofore referred to as e-book, and photo album and its accompanying application or program for an e-book for illustrating and describing activities to a user of the e-book, more particularly, the present invention is directed to such an e-book for activities such as, but not limited to school-day routines.

### BACKGROUND OF THE INVENTION

People, especially children, about to encounter new or unfamiliar situations and experiencing new or unfamiliar situations often find the anticipation and experience very stressful. This can be particularly overwhelming for children entering school. Most children are dropped off in a classroom, their parent or care giver leaves, and they are left to wait for unknown experiences and for an unknown period. This is similar to an adult showing up for a new job without seeing a job description. Knowing what to expect can significantly reduce this anxiety and aid in adapting to the new situation.

Examples of such new experiences are: attending a new school, attending a new church- or faith-based program, becoming involved in a new enrichment program or class, after-school program, being cared for by a babysitter or nanny, participating in morning routines (e.g., getting ready for school), evening routines (wash up, story, staying in child's own bed), summer camp or sports' teams, welcoming a new sibling or pet to the family, moving into a new home, and visiting the doctor or dentist, zoo, library, playground, birthday, or other social encounters with peers.

These new situations also include learning basic manners, e.g., sharing, table manners, introductions, and saying “please,” “thank you,” and “excuse me.”

There is therefore a need to help children and their parents transition to and remain engaged in new experiences, for example, school, enhance parent involvement in their children's activities, for example, school and educational development at school, at home, and in the community, and enhance parent involvement in promoting the institutions which their child interacts with, for example, a school, camp, church, etc. The current invention addresses these needs.

### SUMMARY OF THE INVENTION

The invention herein is directed to an e-book and a system of creating, editing, and displaying a personalized activity e-book.

The system of the invention is made up of a creation subsystem for creating and editing an e-book, and a display subsystem for displaying the e-book.

For the purposes of this application a user is a human entity which is interacting with the system.

For the purposes of this application, “institutions” refers to non-individual entities, for example business, corporations, schools, churches, non-profits, or groups. It should be understood that institutions will likely interact with the system through users who are in some way affiliated with the institution, e.g., work or volunteer for the institution or take action in the name of the institution, however, for the purposes of this application those actions will be considered actions taken by the institution.

For the purposes of this application, “third parties” are all other entities which are not users or institutions. Third parties do not directly provide input to the system and are not affiliated with the system. In some embodiments, the system will accept input from third parties if directed to do so by a user, an institution, or the system. In some embodiments, third parties may optionally view public system information, for example, public e-books, via the display module.

The system may optionally allow different users, different institutions, and/or different third parties different levels of access to its functionality.

The creation subsystem is a subsystem of the system of the invention which allows for the creation and modification of template pages and their respective fields and modules. For example, the creation subsystem allows for the creation of new template pages and/or modules pages in an e-book. In some embodiments all users have access to both subsystems. In some embodiments a user or institution's access to the creation subsystem may be limited or the user or institution may not have any access to the creation subsystem. Limited access to the creation subsystem means a user or institution would be able to access some but not all of the functions of the e-book template fields and modules. Access to these functions will be determined by the system. Template pages, template field and modules are discussed in greater detail below.

In the preferred embodiment, the display subsystem allows a user to experience and interact with the e-book but does not allow any of the creating or editing functionality of the creation subsystem. In some embodiments, third parties and institutions can also use the display subsystem. The functions of the template pages and modules of the system are active and experienced by users when using the display subsystem.

An e-book of the invention is comprised of at least two template pages.

In the preferred embodiments, the e-book has multiple template pages that can be customized by the creation subsystem to create the desired e-book. In the preferred embodiments, the template pages have at least two template fields:

1. a media field, and

2. an information field.

In the preferred embodiments, of the invention both image or video data and text data must be displayed on an e-book template page. In the preferred embodiments, all data on a single template page must be related to the same theme, i.e., same activity, event, topic.

Other optional fields include, for example, the following:

3. an explanation/interaction field,

4. a background field,

5. a border field,

6. a button field,

7. an audio field, and

8. a title field.

In some embodiments, in the creation subsystem, each field may optionally contain text identifying the field or explaining how to use the field that is visible before an input is submitted to the field.

In some embodiments, the number fields, types of fields, and/or the content of the fields on a template page are determined by the system.

In some embodiments, the number fields, types of fields, and/or the content of the fields on a template page are determined by the user or institution in the creation subsystem.

In some embodiments, a user or institution can select to insert a field from a selection of field types provided by the system database.

In some embodiments, the user or institution determines the placement of each field.

In some embodiments, the system determines the placement of each field.

In the preferred embodiments, the media field is the largest field on the template page.

In the preferred embodiments, the media field occupies at least 50% of the display area.

In the preferred embodiment, a template page is displayed as a single page by the system. In some embodiments an e-book may comprise multiple pages displayed sequentially where each page contains at least one template field of the template page.

Using the creation subsystem of the system, a user can search for and select any custom template page to which they have been granted access. Access to template pages is determined by the creator of the template pages. Template pages may be public or private. For the purposes of this application private means only the user or one designated by the user, e.g. an associated institution can access the file from the system data base and public means that any entity can access the file. In some embodiments, the user will have the option of selecting whether they want their uploaded content to be shared with other users or kept private.

Public template pages are open to all users. Private template pages are only accessible to certain users which are determined according to the custom template creator. To access private template pages a user could, for example, provide a password or be identified to the system by the private template pages creator. In some embodiments, access is dependent upon a special relationship to the private template pages creator, for example, enrollment at the school which created the private template pages.

The databases of the system are comprised of at least one memory storage device, for example, a non-transitory computer readable medium.

The system database may contain images, patterns, colors, videos, text, audio, and/or links from the web and images, patterns, colors, videos, text, audio, and/or links uploaded and shared by other users or institutions and links to institutions and third party web sites.

The system database may also contain data saved to the system database by a user or institution, for example, template pages, template fields, modules, and/or entire e-books, where the content of these elements can be included to varying degrees by the user or institution.

### Media Field

The media field of the template pages accepts as input(s) all forms of digital media, for example, digital photos, videos, text, audio, narration, narration with text highlighting, and graphics (stationary or moving). This media can be uploaded by the user from private databases acceptable to the user outside of the system, for example, their private electronic device, an institution's database or a third party database. Additionally, media can be downloaded from the system database. In some embodiments, the media field accepts the insertion of text, for example, on top of the media input. In some embodiments the media field accepts the insertion of audio with or without narration, narration with text highlighting, and graphics (stationary or moving).

In some preferred embodiments, images or videos of the media field are interactive. In some preferred embodiments, portions of the image, for example, objects or people shown in an image, can be identified by the system using the creation subsystem. A user experiencing the e-book in the display subsystem would be able to select these areas of the image which would cause an event to occur. Selecting an area can be achieved by any method used in computing, for example, clicking with a mouse, using a keyboard, touching the area on a touch screen, or activating the area using a motion sensing device.

In some embodiments, the event that occurs is the activation of a link to a website or different page of the book.

In some embodiments, the event that occurs is playing an audio file, text file and/or a video file.

In some embodiments, the event that occurs is causing the selected area to change in some way, for example, change color.

In some embodiments, the event that occurs is to enlarge or zoom in on the selected area.

In some embodiments, the event that occurs is to open a new window which provides more information on that area. This new window is not equivalent to a new template page and therefore need not have both a media field and information field or have both an image or video and text.

In some embodiments, the event that occurs is the enabling of the user to record, play save, and/or delete his/her voice.

These prior examples are merely a sampling and not intended to be an exhaustive list of current or future interactive computing features and functionality.

### Explanation/Interaction Field

The explanation/interaction field of the template pages, either text, video, or audio input relating to the media field, or image input that can interact with the input of the media field via a module of the system. The explanation/interaction field allows for a description or extra information related to the media field to be displayed in text, images, video and/or heard via the playing of an audio file or via the display of additional images or videos. Additionally, this field serves as an area for image, text, and/or audio data to be located that can interact with the data of the media field on the same template page.

In a preferred embodiment, the explanation/interaction field accepts a character-limited description of the activity depicted in the photo or video.

In another preferred embodiment, the explanation/interaction field accepts modules of the system.

In some embodiments, explanation/interaction field content can be saved and/or categorized separately from the template page on which it appears on one of the databases of the system. These saved explanation/interaction fields can be loaded to other template pages upon selection by the creator of the template page.

### Information Field:

The information field contains information which explains the data shown in at least the media field. In the preferred embodiment, the information field contains only text.

In some embodiments the information field contains an audio file.

In some embodiments the information field contains no image or data files.

In some embodiments, the information field contains no interactive functionality.

In some embodiments the information field may contain a header or title.

In some embodiments the information field includes a header or title where the header or title of the information field may optionally be “tips.”

In some embodiments the information field contains information for parents related to the activity depicted in the media field, e.g., how to discuss the school activity depicted in the media field to their child.

In some embodiments, the information field contains “Parent Talking Tips” which provide talking points and informative tips, displayed in text format, which are related to the activities on the template page. These tips are intended to help a parent/caregiver user discuss with a child the activities displayed in the media field.

In some embodiments, the information field contains “Quick Instructions” which provide a brief description of the purpose of the e-book, its intended use, and instructions on how to use and operate the e-book, e.g. recommendations on uploading media, etc.

### Audio Field

In some embodiments, audio files can be uploaded into the fields of the template page. In some embodiments audio files receive a separate field. The audio files can be recorded by the user. In such embodiments, the recorded file can be saved only on the template page where it was recorded or can be saved in the system database with a private or public designation.

In some embodiments, audio files can be uploaded to the system database by institutions or users from a third party database or an internal database of the institution or user.

In some embodiments, the audio file is activated by selecting an icon on the template page. In these embodiments, the icon is a selectable visual image that activates the playing of the audio file. In other embodiments icons can be used as a selectable visual image to activate other actions.

### Border Field, and Background Field

For the purposes of the invention an icon is a visual avatar that can be selected to cause the action of the element which the icon is acting as an avatar for. For example, icons can be used as an avatar for an audio file, where selecting the icon results in the playback of the audio file.

In some embodiments, the icons can be uploaded by a user or institution to the system database from a user database, institution database, or third party database.

In the some embodiments, the system database has preloaded icons for a user or institution to select from.

In some embodiments, institutions have certain icons associated with them which may automatically be used along with optionally the institution's logo and/or background and/or borders in a template page created or edited by an associated users.

Borders define a space between the template fields and around the perimeter of the template fields, and are capable of providing a visual separation between fields.

Backgrounds occupy all screen space not occupied by a template field or border field. In some embodiments the template fields can also have backgrounds which occupy space within the template field not occupied by the input provided by the user. The backgrounds of the template fields and the background of the template page can optionally be the same or different.

In some embodiments the template pages have a border field (borders) and/or a background field (backgrounds).

In some embodiments, logos can be overplayed onto template fields, preferably the title or media fields near the top and near the center. A logo is an image or text symbolizing an institution, for example, the trademark of a company of the shield or mascot of an educational institution.

An associated user is a user which has a designated association with a particular institution within the system. In some embodiments, institutions can upload to the system their own template pages that are pre-loaded with the institution's icon and/or background and/or border. Users affiliated with that institution can then download these preloaded template pages from the system database and provide their own customized content in the various fields, for example, the media and information fields.

In some embodiments a user may only be associated with one institution per e-book. In other embodiments the user may be associated with multiple institutions per e-book, but only one per template page.

In some embodiments, an institution can customize the background and/or borders to reflect the institution or the event/experience that is the subject of the particular template page. For example, if the e-book is related to a child's school experience, the template pages backgrounds and/or borders can include the school's branding and/or mission statement e.g., via placement of color schemes, school logo, mission statement, or can be copied from the school's related customized e-book.

In some embodiments, multiple institutions can customize the background and/or borders to reflect the institutions associated with the e-book or the event/experience that is the subject of the particular template page. For example, if the e-book is related to a child's summer school and summer camp experiences, one of the template page's backgrounds and/or borders can include the school's branding and/or mission statement e.g., via placement of color schemes, school logo, mission statement, or can be copied from the school's related customized e-book. And the other template page's backgrounds and/or borders can include the camp's branding and/or mission statement e.g., via placement of color schemes, school logo, mission statement, or can be copied from the camp's related customized e-book.

In some embodiments, institutions can upload and save an institution's logos, backgrounds, and/or borders to the system database. A user can then optionally select the institution background and/or border in the creation subsystem. Such a selection by the user will result in the institution background and/or border being applied to the user's template pages. In some embodiments, institutions can create entire template pages referred to as institution template pages and upload them to the system. Institution template pages include inputs for at least one template field and may include all template fields. A user can then select and insert the institution template page(s) into the user's e-book. Users can also optionally edit the selected institutional template pages.

In some embodiments, institutions can create entire e-books (institution e-books) and upload them to the system, or have them remain on the institution's system, e.g. institution's web site. In some embodiments, the institutions provide all of the content for the e-book. In these embodiments, users provide no content to the institution e-books but will be able to view the institution e-books using the display subsystem. In some embodiments, users can edit the institution e-books. Such editing transforms the institution e-book into a user e-book. Users will therefore be unable to change the institutional e-book saved on the system but will be able to create user e-books using the institutional e-book as a model.

In other embodiments, at least one template field is provided by the institution and at least one template field is provided by the user. For example, the institution could provide the media field and the user would complete the e-book by providing the explanation field or vice versa. This provides the advantages of providing institution-branded template pages to users and encouraging users to personalize the template pages to reflect their own experiences. This also supports the dissemination of user-generated content for marketing purposes when the template pages that are customized by the institution and personalized by the individual user are shared through institutions' web sites and 3^{rd} party web sites, including social media sites.

### Title Field

The title field is a text only field containing the title of the particular template page on which it appears. In the preferred embodiment, the title relates to the information contained in all the other fields of the template page on which it appears.

In some embodiments, a title field is provided. In the preferred embodiment the title field is provided at the top of the display. The title field receives input regarding the title of the template page, for example text input. In some embodiments, the user provides a custom title. In some embodiments, the user selects from titles provided by the system.

In some embodiments, the e-book creation template is comprised of a fixed number of template pages with pre-determined titles. In these embodiments the titles all relate to common real life experience, for example, the pre-determined titles all relate to activities performed during the school day of a child. In some embodiments, the user can edit the titles, and the number of template pages.

In some embodiments, a user can choose to upload a default field to the system. For the purposes of this application, a default field is a template field input associated with a specific title. The system will automatically display the default field when the associated title selected for a template page. A default field may optionally be used with any template field of the system.

### Button Field

The button field is a field where buttons are located. Buttons are areas of the button field symbolized by icons which can be selected by a user. Selecting a button causes an action to occur.

In some embodiments, the buttons are any combination of the following:
“New Page”: creates a new template page of the e-book.
“Delete”: Deletes the current page and displays the next page.
“Save”: Saves the e-book content up to and including the current page.
“Right pointing arrow”: Turns to next page of e-book.
“Left-pointing arrow”: Turns to previous page of e-book. (This function does not exist on the e-book cover, since there is no previous page to the cover.)
“Record Your Voice”: records a user's voice and stores it as an audio file that can be selected and included in a e-book. Selecting this tab will provide the user with the following additional tabs:
“Record”: Starts recoding.
“Stop”: Stops the recording.
“Play”: Plays the recording.
A user can then selected whether to save the recording on the system or delete it.

### Modules

In some embodiments, the system included modules. Modules define the interactive actions of the system.

In some embodiments, some combination of the following modules are included in the system:

theme module,

drag and drop module,

draw and color module, and

point and click module.

The theme module allows an institution to provide a theme and description of the theme to the system database and optionally also to the institution database. A user or associated user (user associated with the institution which provides the theme) can select that theme from the system database and optionally also from the institution database. The selection by the user causes the generation of at least one template page with at least one predetermined field related to the theme. The predetermined fields are optionally determined by the institution or the system. The generated template page will also include the theme and description provided by the institution written in text in either the title field or in the some other field of the generated template page.

In some embodiments, the institution or system may select/limit the fields to be used in the template and optionally determine the placement of each field on the template page.

After the template page is generated, a user will provide inputs to the open fields selected by the institution or system and optionally add more fields and provide inputs to those fields as well. The resulting template page will be saved to the system and accessible to the institution that created the theme.

In the preferred embodiment, an e-book is created by the system using the template pages provided by users of a common institutional theme.

The drag and drop module is an interactive module whereby small images or icons from one field can be dragged and dropped into a different field or optionally a different area of the same field. In the preferred embodiments, the small images or icons are not located in the media field and are preferably located in the explanation/interaction field.

In the preferred embodiments of the drag and drop module, the small images or icons are related to the larger image shown in the media field can be selected and placed onto the image in the media field.

In some embodiments the placement of images from the explanation/interaction field onto the media field may optionally cause an event to occur, for example, the playing of an audio, text or video field, having the image from the explanation/interaction field disappear, or the display of an alternative image in the media field. In some embodiments, the images from the explanation/interaction field must be placed in specific areas of the media field. In some embodiments, the specific areas were designated in the creation subsystem or provided by the system database.

The draw and color module allows a user to draw or color on the media field. In some embodiments a user can select from a variety of line and color options. The options may be optionally presented as buttons or in the explanation/interaction field.

In some embodiments, the module also includes image manipulation abilities that are well known in the art, for example, changing the brightness, coloring, shading, and size of the image and also applying various image manipulation effects to the media field.

The point and click module functions with a mouse, keyboard, or touch screen. The point and click module functions allowing a user to select an element in the media field and or the explanation/interaction field and have that selection cause some action. The selection is made, for example, by clicking on the element or tapping a touch screen. The point and click module allows areas inside of fields of a template page to be designated in the creation subsystem or provided by the system database which when selected cause an action to occur.

In the preferred embodiments, the designated areas are in an image displayed in the media field. Those designated areas are generated around, for example, objects, people, or elements shown in the image. When the designated areas are selected by a user, some action occurs.

In the preferred embodiments, that action is related to the, for example, object, person, or element shown in the image which the designated area was located on. The actions can be for example, the playing of an audio file of a person talking, particularly if the designated area was located on a person.

The selection of a designated area could change the color of that area or generate a noise associate with the object or element.

The selection of a designated area could change the image shown in the designated area, for example, causing the object or element to disappear or be replaced by a different object or element.

In some embodiments, the selection of a designated area activates a link to a third party website or alternative e-book template page. In some embodiments, a link to a different webpage within the e-book, to an institution's web site/system, or to a third party website can be provided in the text field. Links can optionally be included in any field.

In some embodiments, the system of the invention can be integrated with an existing institution web site/system with a link. This link is provided on the institution web site and directs the user away from the institution web site and to a different remote site that houses the system of the invention. This remote site can be, for example, a web site, server, or cloud.

This remote site enables the third party to control the content and the functionality of the system of the invention without fully integrating the system of the invention with the institution web site/system. Therefore, potential compatibility problems between the system of the invention and the institution web site/system can be avoided.

The remote site can also mimic or replicate the institution web site/system's navigation so that it does not appear to the user that he/she is leaving the institution web site/system. In some embodiments, the remote site includes the institution's brand, for example, custom institutional template pages.

In some embodiments the system of the invention can be directly integrated into an institution system. In these embodiments, the system of the invention is accessed directly from the institution web site/system, for example, by the user via a tab on the school web site.

In some embodiments, the system allows for a display device which is displaying an aspect of the system to automatically adjust its display according to its screen size and format. Additionally, the functionality of the modules of the system can be operated using any methods for interacting with electronic devices for example, keyboards, mouse, touch screen, eye motion tracker, body motion tracker, etc. In some embodiments, the system is capable of operating on or is compatible with any software operating system. In some embodiments the system can be operated on any electronic device, for example, desktop computers, tablets, laptops, e-readers, calculators, and other hand held electronic devices that include a display.

In some embodiments, e-books, template pages, or individual fields can be organized into albums. An album is a collection of e-books, template pages, or individual fields organized around a theme, institution, or event.

In some embodiments, the system applies a date stamp to the creation and modification of template pages and e-books.

In some embodiments, the system can be linked/synced with calendar applications for the purposes of record keeping.

In some embodiments, the e-books or template pages can be printed.

In some embodiments the e-book can additionally include a School-day Diary page. This page provides the parent/caregiver with a list of recommended talking points and questions to serve as conversation starters to encourage their child to talk about his/her school-day experience. This page includes buttons that allow the child to record and play back their own voice discussing their school experiences. This reinforces research on the effective use of technology by children because it: 1) allows children to share samples of work created with technology with their parents and others as a record of the child's accomplishments, particularly since children are able to create a record of their recordings by using the “save” button; and 2) encourages parents to use “computer time” to talk to their children.

In general, the embodiments of the invention provide a user with the ability to create a personalized interactive activity book and photo album. The embodiments of the invention extend to all possible versions of this personalized interactive activity book and photo album—including but not limited to: multiplatform-, print-, digital-, Web-, computer-, electronic-, and DVD-based, mobile, wireless, video (incl. streaming video and podcasts), audio, interactive video games, and software and computer programs. For example, this same book content via an interactive Web site, computer or software program, electronic book (or e-book), and/or DVD. This invention is expressed in books, audio books, electronic books, Web-based books, DVDs, CDs, interactive videogames, board games, and interactive content.

Some advantages provided by the various embodiments are, for example:

1) helping a user become more comfortable with routines (including but not limited to daily routines) and new and/or unfamiliar experience(s),

2) teaching a user a desired behavioral pattern, and

3) helping a user become more comfortable with routines (including but not limited to daily routines) and new and/or unfamiliar experience(s), e.g.,: attending school or camp; executing bedtime routines (e.g. taking a bath, putting on pajamas, picking a story book to read, getting into bed, staying in child's own bed); executing morning routines (e.g., getting dressed, eating breakfast, getting ready for school); getting used to a babysitter or nanny; cleaning up one's toys and other possessions; staying with a baby sitter; spending the night at a friend's house; joining a sports team; welcoming a new sibling and/or pet to the family; visiting the doctor or dentist, etc.

Teaching a user a desired behavioral pattern within the context of routines and new and/or unfamiliar experience(s), include but are not limited to all of the above-mentioned experiences in the previous paragraph and also manners (e.g., sharing, table manners, meeting people and making introductions, etc.); eating nutritious foods; safely coping with food allergies or other food concerns (what to eat and avoid); how to respond to bullying: e.g., how to avoid becoming a bully at school (or other setting), how to respond to being bullied, and how to respond when you see someone else being bullied.

These advantages are accomplished, in part, because the e-book is customizable, i.e., it allows the child to depict his/her own individual tasks, environments, routines, and schedules, and additionally, his/her reactions, thoughts and feelings related to those individual tasks, environments, routines and schedules. There are multiple types of customizable experiences, for example:
1. A child can take his electronic device to school and populate the “(insert child's name) goes to school” e-book with pictures as his daily routine progresses by taking pictures with his electronic device. Similarly, the child can take his electronic device into any environment that reflects the topic of the e-book (e.g., camp, morning routine, bedtime routine, using a babysitter, etc.) and take pictures and create his e-book as his day/routine progresses. This particular use of the e-book/application provides immediacy, like a reporter taking photos and adding descriptions while he/she is still in the environment.
   or
2. A child can populate the e-book with previously-taken photos or a combination of previously-taken photos and current photos (as described in #1).

The result is an e-book that creates a sense of familiarity with a new task or any other task depicted in the e-book, via the personalization and customization features, thereby decreasing stress in the child in relation to the depicted task or routine and therefore in the parent or caregiver as well.

In some embodiments, an e-book cover is provided with a designated field for receiving media uploaded by a user of either:
An image of the person who is the subject of the e-book and described by the title field; or
An image provided by the system.

In some embodiments, an e-book cover is also provided with a second field for a user's name, for example, the name of the child who is a user and subject of the e-book and/or who is depicted in the photograph on the cover.

In some embodiments, an e-book cover is also provided with a third field for the title of the e-book.

In some embodiments a sample E-book, can be selected from the system database. If selected by a user, the sample e-book displays every page of a completed e-book for the user to view. The sample e-book may be, for example, an example to help instruct a user on how to personalize the e-book or an e-book provided on the system by an institution or other users.

In some embodiments, the system provides more than one sample e-book that can be viewed by a user.

In some embodiments, the system displays a sample e-book selected by the user which can also serve as a sample to help instruct the user on how to build a personalized e-book.

The user may also view past complete e-books that the user has created. In some embodiments, the e-book cover also has a field titled, “Help for Stressed-Out Kids and Parents: from the Author.” Selection of this field by the user results in the display of a video of a person speaking about the usefulness of the e-book, or a text introduction re: the usefulness of the e-book.

In some embodiments, the system provides for the following functionality:

Each child in a classroom, using the system, would have the ability to populate their own template page(s) and upload along with the other kids' template pages stored on the schools website (institutional database), resulting in the creation of an e-book that has different child authors for each page of the book.

In some embodiments the system provides for the following functionality:

Schools could associate themselves with other schools within the system, e.g., Montessori schools. These associated schools could then use the system to author their own page or set of pages (like a chapter) of the e-book and combine their pages with the pages authored by other associated schools in the system to form an e-book.

The embodiments of the system are supported by at least a processor component, memory component, and graphical user interface (GUI) to facilitate the functionality disclosed above. The processor executes instructions stored in the memory of databases of the system to exchange information between the various databases and subsystems. The memory stores the data needed for e-book content and operations. Further, the memory may be accessible by the components within system without being physically located with these components, such as through a wireless network.

In some embodiments, the GUI may receive the inputs and enable the transmission of display outputs to an electronic device which can be operated by, for example, a user.

In some embodiments, the GUI facilitates the creation and transmission of visual representations to an electronic device using the display and creation subsystems of the system. In some embodiments, the GUI supports template pages.

In some embodiments, the GUI is generated according to the disclosed embodiments by executing instructions with the processor as instructed by the various inputs and/or subsystems within the system.

In some embodiments, the electronic book comprises at least two template pages, wherein said template pages are comprised of at least two fields, wherein two of the at least two fields are a media field and an information field, wherein all template pages have at least media input and at least text input.

In some embodiments, the electronic book additionally comprises a drag and drop module, a point and click module, or a combination thereof.

In some embodiments, the at least one word of text is provided at least in the information field and the at least one image or video is provided at least in the media field.

In some embodiments, the electronic book additionally comprises at least one additional field selected from the group consisting of:

A. an explanation/interaction field,

B. a background field,

C. a border field,

D. a button field,

E. an audio field, and

F. a title field.

In some embodiments, said media field comprises at least 50% of the total area of the template page.

In some embodiments, the at least one of the template fields includes an icon, a link, or a combination thereof.

In some embodiments, all template fields of a template page relate to the same topic.

In some embodiments, all template fields have some content.

In some embodiments, the invention is a method of creating the electronic book comprising:
A. providing at least two template pages wherein said template pages are comprised of at least two fields including a media field and an information field, and wherein all template pages have content comprised of at least one media and at least text input;
B. receiving at least one media input and at least one text input wherein the media input is applied to at least the media field and the text input is applied to at least the information field;
C. modifying the at least two template pages according to the at least one media input and at least one text input; and
D. performing at least one of:
   i. storing said at least two template pages on a system database, user database, or institutional database;
   ii. transmitting said at least two template pages to an electronic device.

In some embodiments, the at least one template editing input is determined by a theme module.

In some embodiments, the modules consist of a drag and drop module, a point and click module, or a combination thereof.

In some embodiments, all template fields of a template page relate to a topic.

In some embodiments, at least one of the template fields includes an icon, a link, or a combination thereof.

In some embodiments, all template fields have content.

In some embodiments, section B (above) additionally includes receiving at least one template editing input from a user or institution wherein said template editing input comprises:

a. insertion or deletion of a template field,

b. editing content of a template field,

c. insertion or deletion of a module, or

d. editing content of a module;

with the caveat that the media field and information field cannot be deleted.

In some embodiments, the e-book additionally includes a School-day Diary page.

In some embodiments, the e-book template pages are viewed as a rolling display.

### BRIEF DESCRIPTION OF THE DRAWINGS

FIG. 1 is a block diagram of the system.

FIG. 2 is a block diagram of the theme module.

FIG. 3 is an example of a template page.

FIG. 4 is another example of a template page.

FIG. 5 is another example of a template page.

FIG. 6 is an example of a link related to the template page shown in FIG. 5.

FIG. 7 is another example of a template page.

FIG. 8 is an example of a draw and color module.

FIG. 9 is an example of a template page in the creation subsystem.

### DETAILED DESCRIPTION OF THE DRAWINGS

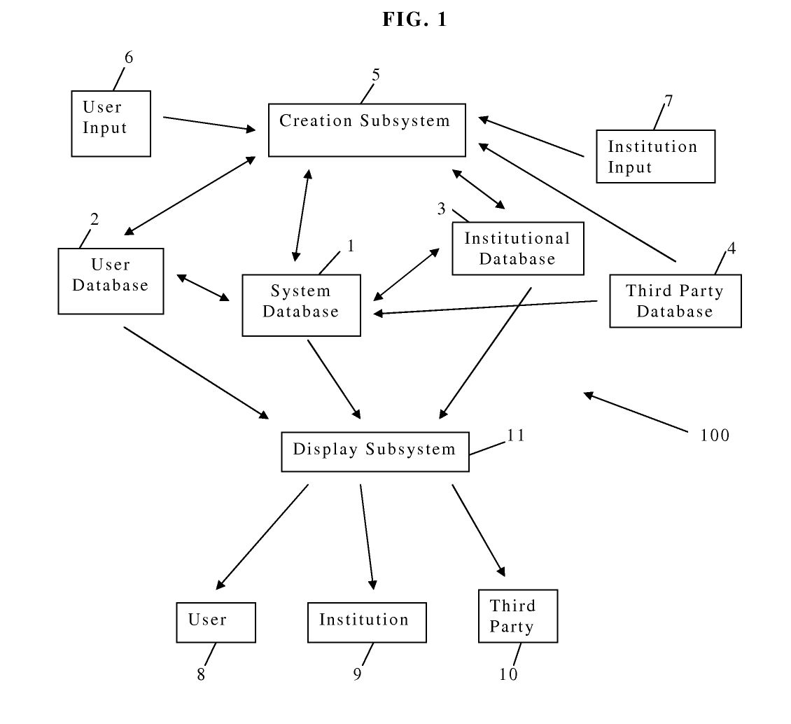

FIG. 1 is a block diagram of the system 100 showing all possible inputs and outputs. The system database 1 can send and receive output and input from the creation subsystem 5, user database 2 and the institutional database 3. The system database can receive input from a third party database 4 at the direction of a user or institution but it does not send output to the third party database 4.

The creation subsystem 5 can receive input from the system database 1, user database 2, the institutional database 3, the third party database 4, user input 6, and institutional input 7. The creation subsystem 5 can send information to the system database 1, the user database 2, and the institutional database 3.

The system database 1, user database 2, and the institutional database 3 can send input to the display subsystem 11 which then can send information to a user 8, institution 9, and a third party 10.

In the preferred embodiments, the transfer of data is at least partially controlled and directed by a user or an institution.

In the preferred embodiments, an e-book is created in the creation subsystem 5. A user 8 or institution 9 can select data from the system database 1, the user database 2, the institutional database 3, or the third party database 4 and arrange that data according to their preference through user input 6 or institutional input 7. In some embodiments, multiple users 8 can collaborate on a single e-book or template page. In some embodiments, one or more users 8 can collaborate on a single e-book or template page with one or more institutions 9.

In the preferred embodiments, the display subsystem 11 receives the e-book information from the system database 1, the user database 2, or the institutional database 3 that was created using the creation subsystem 5.

A user 8, institution 9, or third party 10 can use the display subsystem 11 to view and optionally interact with the e-books created in the creation subsystem 5 and stored on system database 1, the user database 2, or the institutional database 3.

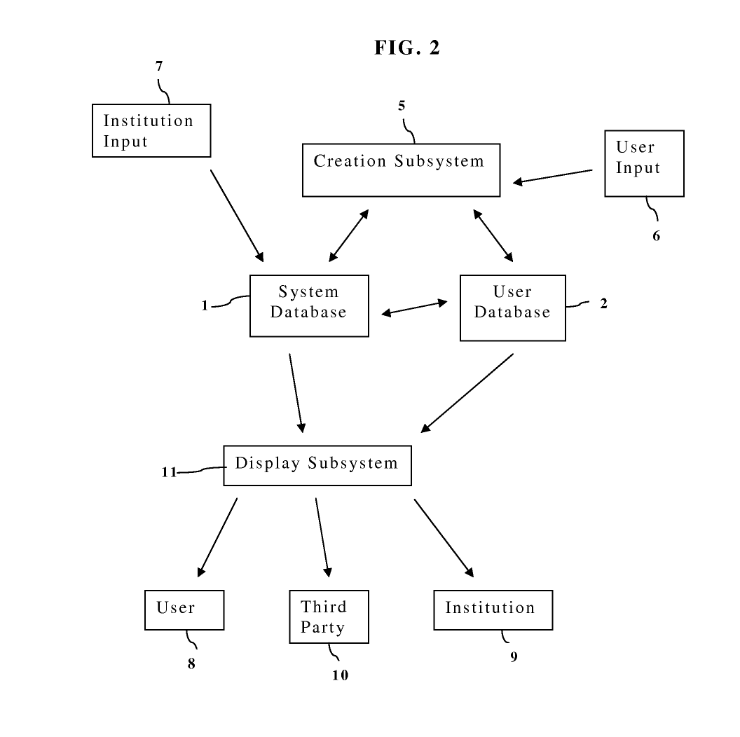

FIG. 2 is a block diagram of the theme module showing all possible inputs and outputs. The arrows in the figure represent the possible flow of information.

In the preferred embodiment, the institution will provide input 7 regarding a theme and description of the theme to the system database 1. Using this data, a user will provide user input 6 to create an e-book or template page. The user can optionally select data from the user database 2 or the system database 1 to create the e-book or template page in the creation subsystem 5. The e-book or template page can then be stored in the system database 1, the user database 2, or the institutional database 3.

A user 8, institution 9, or third party 10 can use the display subsystem 11 to view and optionally interact with the e-books created in the creation subsystem 5 and stored on system database 1, the user database 2, or the institutional database 3.

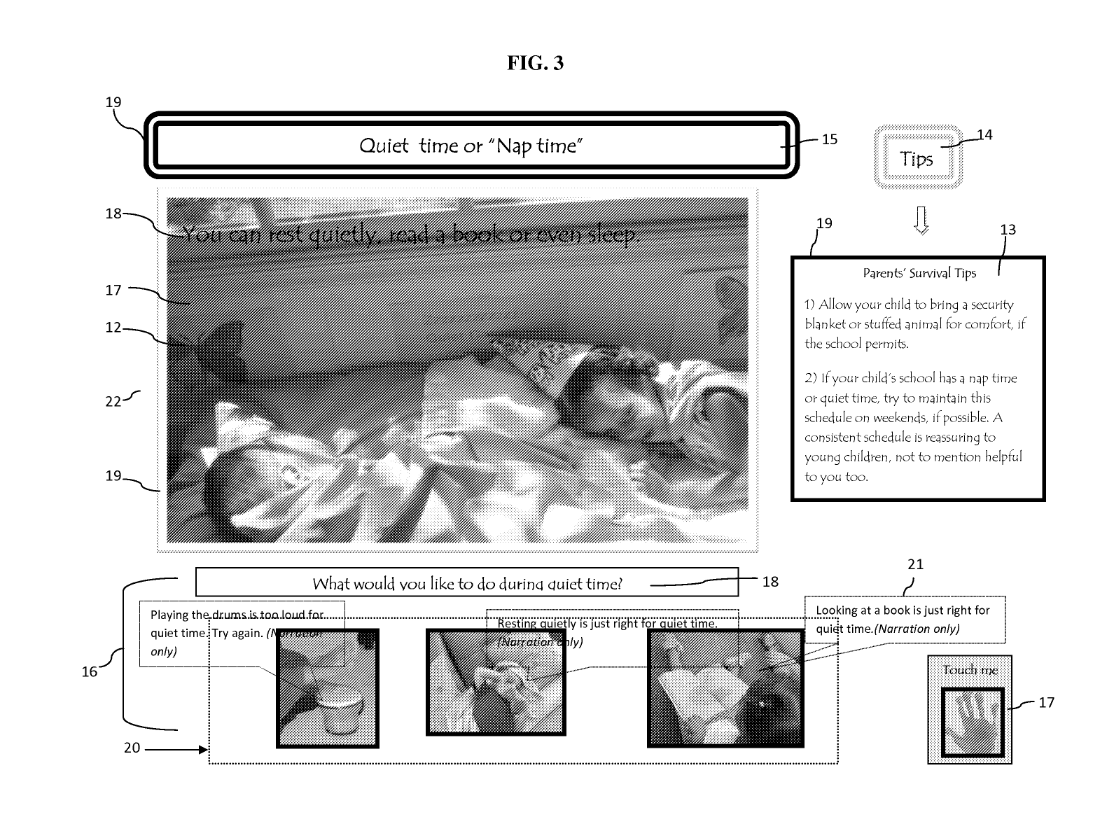

FIG. 3 is an example of a template page of the system. FIG. 3 shows a media field 12, information field 13 with header 14, a title field 15, and explanation/interaction field 16. The fields also have borders 19. The background 22 is white. The data in all fields are related. The title field 15 contains text data 18 stating the theme/event of the template page.

The media field 12 has image data 17 with text data 18 overlaying the image data 17. The information field 13 contains text data for parents.

The explanation/interaction field 16 contains a point and click module 20 where selecting one of the images shown in the explanation/interaction field 16 cause the action of an audio narration which optionally also show the text being narrated. In the embodiments where the text is not shown, the text boxes 21 shown in the figure will not be displayed. The explanation/interaction field 16 also contains text data 18 and image data 17 that may contain instructions for operating a module of the system, for example, the point and click module 20.

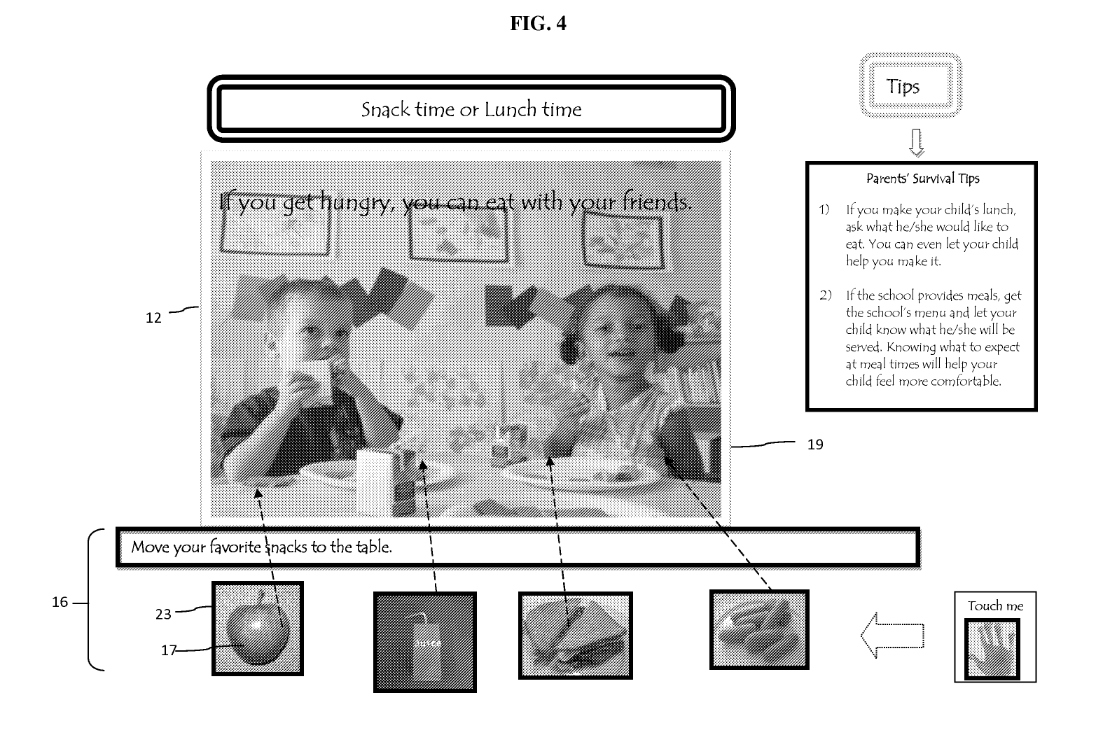

FIG. 4 is an example of a template page of the system. FIG. 4 includes many of the fields discussed in FIG. 3. FIG. 4 also includes a drag and drop module. The image data 17 acts as an icon 23 for data that can be matched with specific portions of the media field 12. Each icon 23 can be selected, moved into the media field 12, and dropped.

When dropped in the correct portion of the media field, i.e. the specific portion of the media field 12 that has been predetermined for that icon 23, an action indicating the match will occur. For example, the icon 23 will disappear, image data 17 in the media field 12 will be modified or replaced to show the image data 17 of the icon 23, an audio file will be played, or the icon will change color. If the icon 23 is dropped in the wrong area of the media field 12, a different action will occur, for example, the icon will return to the explanation/interaction field 16 or will change a different color than when the correct area was indicated.

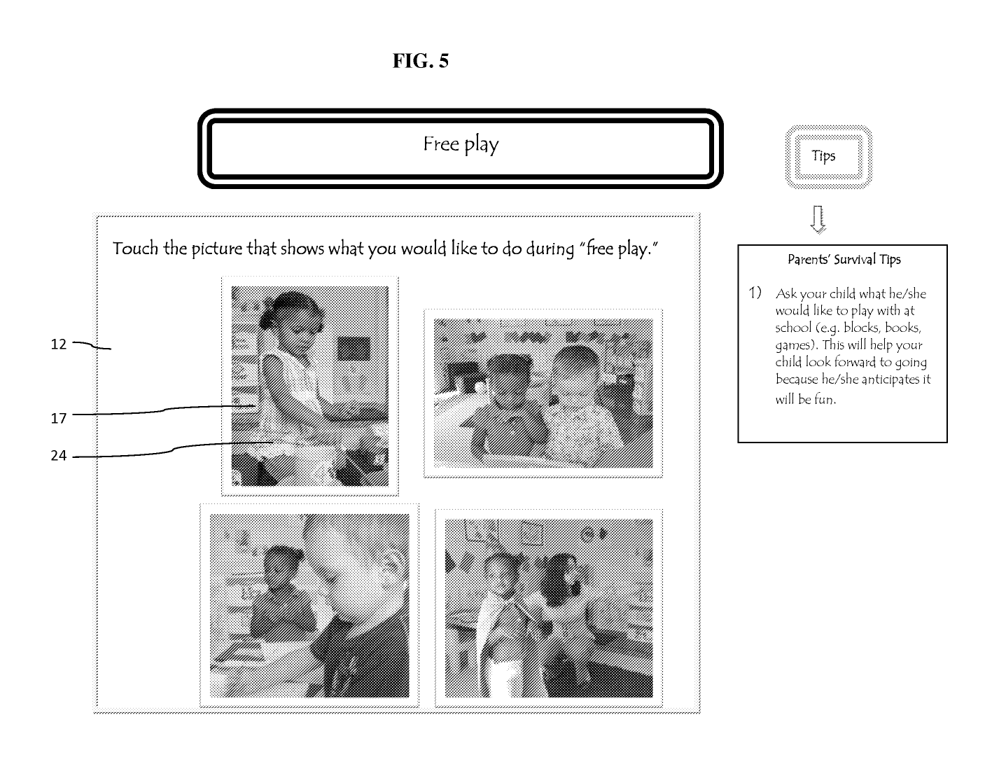

FIG. 5 is an example of a template page of the system. FIG. 5 includes another example of a point and click module an example of a link 24. The point and click module is located in the media field 12. When an image data 17 from the media field 12 is selected, the action that occurs is the activation of a link 24.

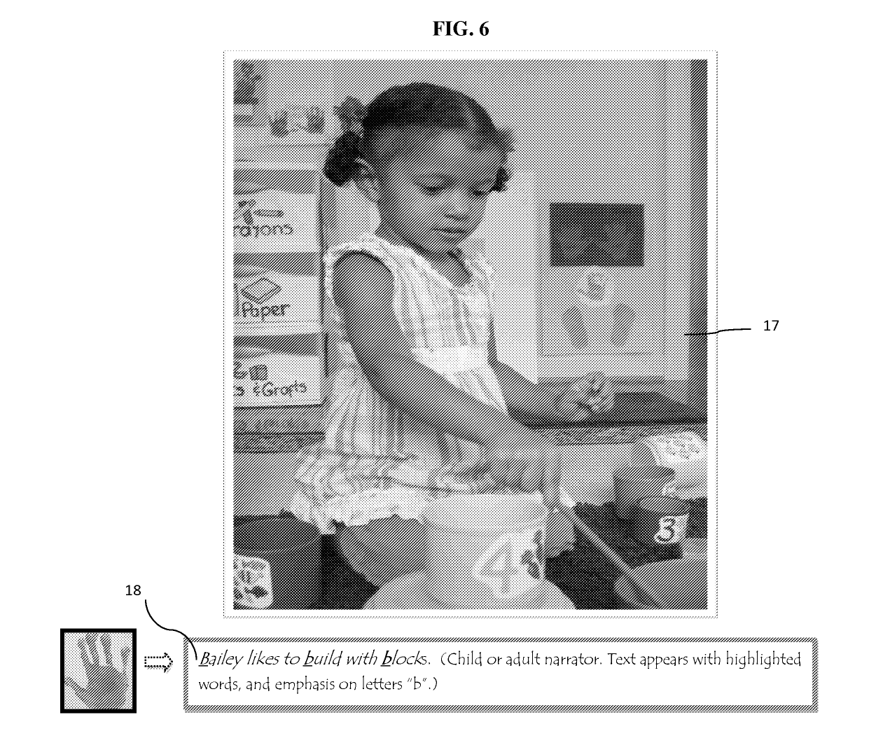

FIG. 6 is an example of a link related to the template page shown in FIG. 5. FIG. 6 shows the page that is linked from template page shown in FIG. 5. The image data 17 is repeated from the template page shown in FIG. 5. Additionally, in this embodiment, audio is played with text 18 of the words in the audio.

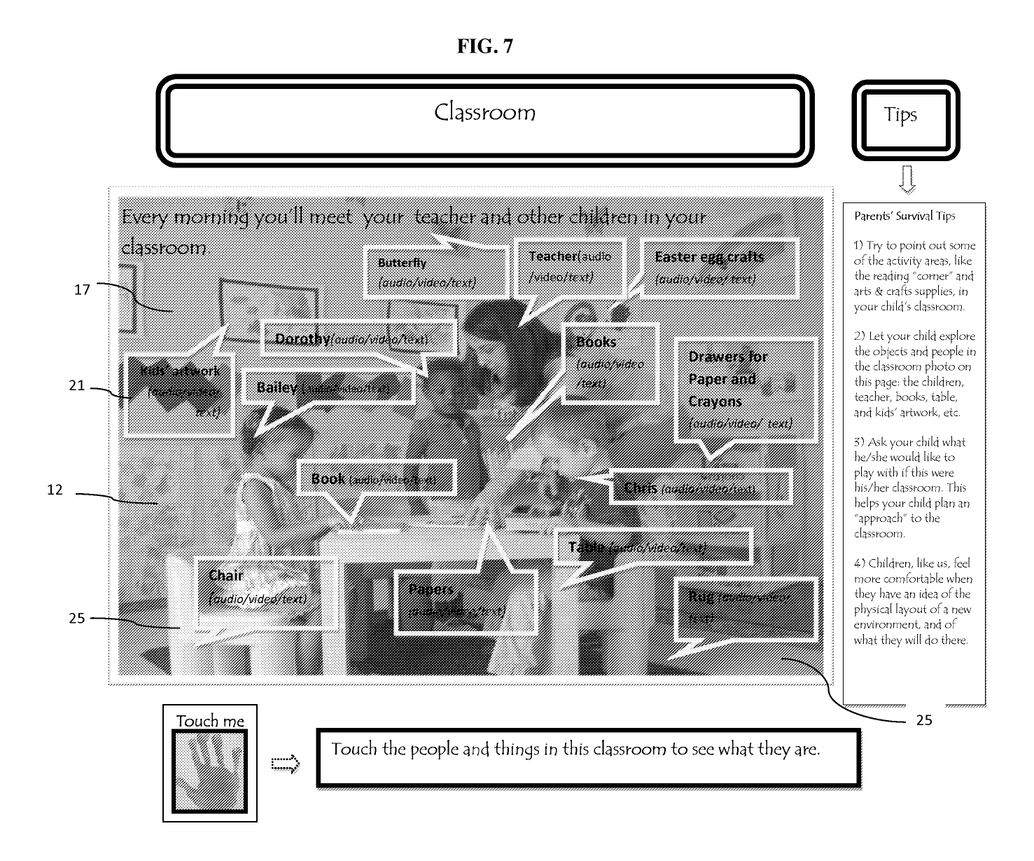

FIG. 7 is another example of a template page. FIG. 7 illustrates another example of a point and click module where the point and click module is located in the media field 12. Areas 25 of the image data 17 in the media field 12 have been pre-designated. These areas 25 are pre-designated based on the elements shown in the image data 17. When these areas 25 are selected an action is caused to occur. The action can be, for example, the playing of audio, appearance of text, the playing of a video, and/or the activation of a link. The text boxes 21 are optionally shown either before or after the selection of an area 25.

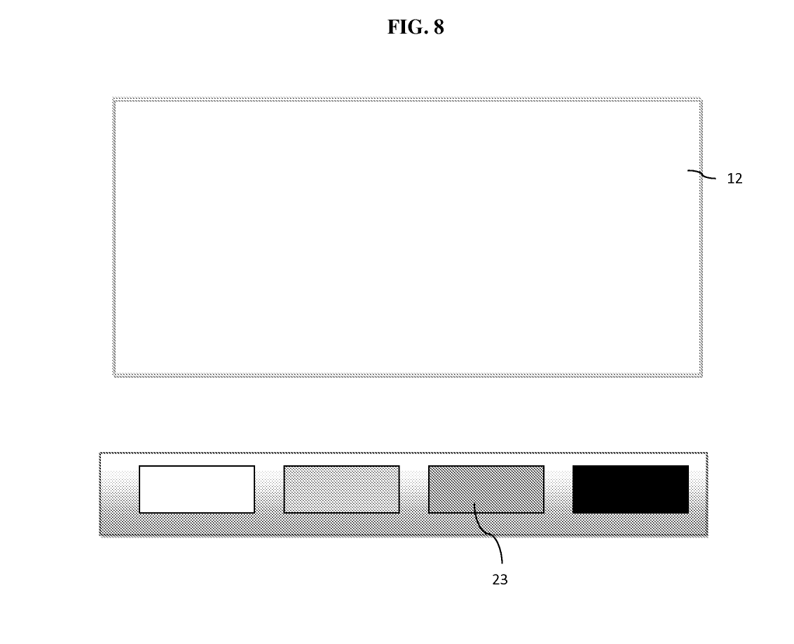

FIG. 8 shows an example of the draw and color module. An image may be optionally loaded in the media field 12. Icons 23 in the explanation/interaction field indicate the tool that will be activated when that particular icon 23 is selected. For example, FIG. 8 shows four icon 23 in the form of boxes where each box is a different color. When a user selects an icon 23, the user will be able to draw in the media field in the color which was indicated by the icon 23.

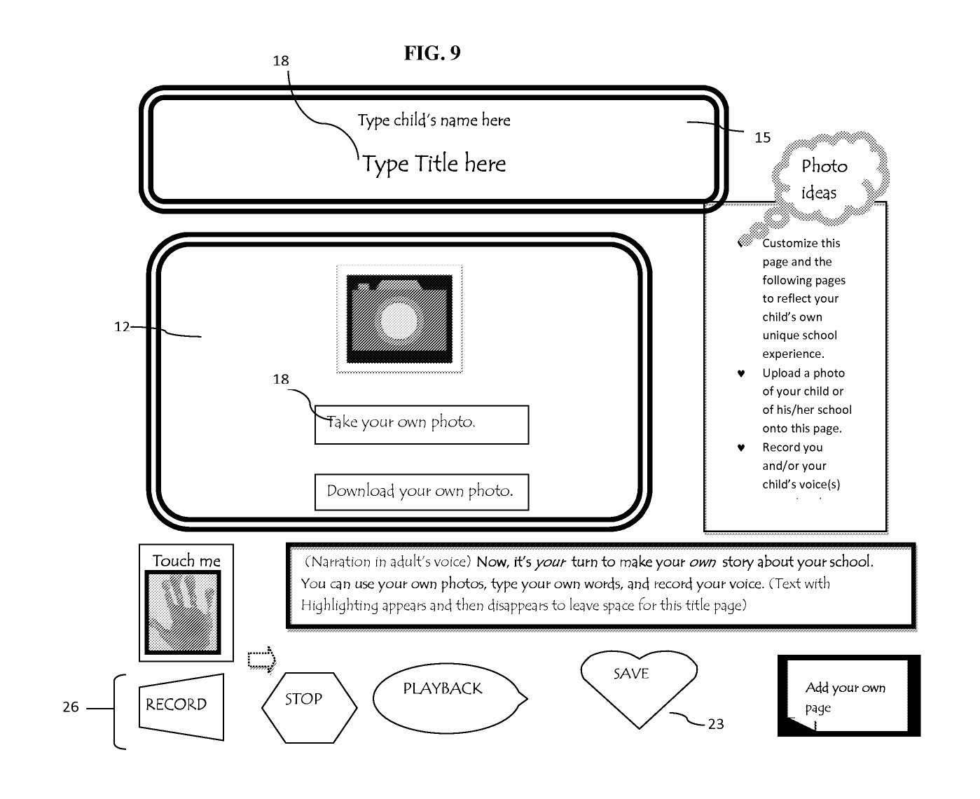

FIG. 9 is an example of a template page in the creation subsystem. FIG. 9 shows various empty fields, for example, the title field 15, and the media field 12. The fields may optionally contain instructional text data 18.

FIG. 9 also includes a button field 26. Buttons are areas of the button field symbolized by icons 23 which can be selected by a user using the point and click module. Selecting a button causes an action to occur. For example, recording the user's voice.

The disclosed embodiments may be supported and executed on a platform that has access to a network. The platform may support software and executable programs to provide the functionality disclosed above. For instance, the software may be deployed. Any software embodying the e-book and its processes may be deployed by manually loading directly to the client, server and proxy computers via loading a storage medium such a CD, DVD, flash memory, chip, downloadable program and the like. The software also may be automatically or semi-automatically deployed into a computer system by sending the process software to a central server or a group of central servers. The software is downloaded into the client computers that execute the programs and instructions associated with the software.

Alternatively, the software may be sent directly to the client system via email. The software may be detached to a directory or loaded into a directory by a button on the email that executes a program that detaches the software into a directory. Another alternative is to send the software directly to a directory on the client computer hard drive. When there are proxy servers, the disclosed embodiments will select the proxy server code, determine on which computers to place the proxy servers' code, transmit the proxy server code, and install the proxy server code on the proxy computer. The software may be transmitted to the proxy server and then stored on the proxy server.

As will be appreciated by one skilled in the art, the present invention may be embodied as a system, device, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more computer systems coupled to a network capable of exchanging information and data. These computer systems also may be general-purpose computer systems. Various functions and components of the computer system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications and variations can be made in the disclosed devices and processes without departing from the spirit or scope of the invention. Thus, it is intended that the present invention covers the modifications and variations of the embodiments disclosed above provided that the modifications and variations come within the scope of the claims and their equivalents.

What is claimed is:

1. An electronic book comprising at least two template pages, wherein said template pages are comprised of at least two fields, wherein two of the at least two fields are a media field and an information field, wherein all template pages have at least media input and at least text input.

2. The electronic book of claim 1 wherein the electronic book additionally comprises a drag and drop module, a point and click module, or a combination thereof.

3. The electronic book of claim 1 wherein the at least one word of text is provided at least in the information field and the at least one image or video is provided at least in the media field.

4. The electronic book of claim 1 wherein the electronic book additionally comprises at least one additional field selected from the group consisting of:
A. an explanation/interaction field,
B. a background field,
C. a border field,
D. a button field,
E. an audio field, and
F. a title field.

5. The electronic book of claim 1 wherein said media field comprises at least 50% of the total area of the template page.

6. The electronic book of claim 1 wherein at least one of the template fields includes an icon, a link, or a combination thereof.

7. The electronic book of claim 1 wherein all template fields of a template page related to the same topic.

8. The electronic book of claim 1 wherein all template fields have some content.

9. A method of creating the electronic book of claim 1 comprising:
A. providing at least two template pages wherein said template pages are comprised of at least two fields including a media field and an information field, and wherein all template pages have content comprised of at least one media input and at least text input;
B. receiving at least one media input and at least one text input wherein the media input is applied to at least the media field and the text input is applied to at least the information field;
C. modifying the at least two template pages according to the at least one media input and at least one text input; and
D. performing at least one of:
i. storing said at least two template pages on a system database, user database, or institutional database;
ii. transmitting said at least two template pages to an electronic device.

10. The method of claim 9 wherein at least one template editing input is determined by a theme module.

11. The method of claim 9 wherein the modules consist of a drag and drop module, a point and click module, or a combination thereof.

12. The method of claim 9 wherein all template fields of a template page relate to a single common topic.

13. The method of claim 9 wherein at least one of the template fields includes an icon, a link, or a combination thereof.

14. The method of claim 9 wherein all template fields have content.

15. The method of claim 9 wherein section B additionally includes receiving at least one template editing input from a user or institution wherein said template editing input comprises:
a. insertion or deletion of a template field,
b. editing content of a template field,
c. insertion or deletion of a module, or
d. editing content of a module;
with the caveat that the media field and information field cannot be deleted.

16. The e-book of claim 1 wherein the e-book additionally includes a School-day Diary page.

17. The e-book of claim 1 wherein the e-book template pages are viewed as a rolling display.
